(19) United States
(12) Patent Application Publication
(10) Pub. No.: US 2025/0178694 A1
(43) Pub. Date: Jun. 5, 2025

(54) CRANK TRANSMISSION ASSEMBLY FOR A BICYCLE

(71) Applicant: CLASSIFIED CYCLING BV, Antwerpen (BE)

(72) Inventor: Roëll Marie VAN DRUTEN, Eindhoven (NL)

(21) Appl. No.: 18/968,218

(22) Filed: Dec. 4, 2024

(30) Foreign Application Priority Data
Dec. 4, 2023 (NL) 2036416

(51) Int. Cl. B62M 11/14; B62M 6/55; B62M 9/06; B62M 25/08

(52) U.S. Cl. CPC B62M 11/145; B62M 6/55; B62M 9/06; B62M 25/08

(57) ABSTRACT

The disclosure relates to a crank transmission assembly for a bicycle, comprising a crank housing; a primary axle associated with a primary axis; and a secondary axle offset from the primary axle and associated with a secondary axis. A first transmission is operative between a first transmission input rotatable about the primary axis and a first transmission output rotatable about the secondary axis. A second transmission is operative between a second transmission input rotatable about the secondary axis and a second transmission output rotatable about the secondary axis. The secondary axle is torque-supported by the crank housing only on one axial side of the first transmission output.

### FIELD

The invention relates to crank assemblies for bicycles, particularly to crank assemblies including an internal transmission.

### BACKGROUND

Bicycles may include an internal transmission system that is accommodated by a transmission housing. Internal hub transmissions are known where a gear shifting mechanism is accommodated by the wheel hub of a driven wheel of the bicycle. Internal crank transmissions are also known where a gear shifting mechanism is accommodated by a crank housing at or near the crank of the bicycle. Internal crank transmission typically include an input axle that is connected to a crank of the bicycle, through which a user can deliver rotational power to the input axle. Via a, e.g. speed increasing and/or decreasing, transmission, rotational power is transferred from the input axle to an output axle. The output axle may be connected to a chain wheel, which can engage a chain or belt for transferring the rotational power to the driven wheel of the bicycle. The output axle may be either coaxial with the input axle, or offset therefrom.

Modern crank assemblies require little maintenance, particularly due to effective sealing of the internal transmission from the environment by the crank housing. A downside is, however, that in case of failure or malfunction of the internal crank transmission assembly components, particularly of the internal transmission, the crank transmission assembly is cumbersome to repair, and therefore often replacement entirely.

### SUMMARY

It is an aim to provide a crank transmission assembly that is less cumbersome to maintain.

Aspects of the disclosure provide a crank transmission assembly for a bicycle, comprising a crank housing; a primary axle associated with a primary axis; and a secondary axle offset from the primary axle and associated with a secondary axis. A first transmission is operative between a first transmission input rotatable about the primary axis and a first transmission output rotatable about the secondary axis. A second transmission is operative between a second transmission input rotatable about the secondary axis and a second transmission output rotatable about the secondary axis.

In one particular aspect, the secondary axle is torque-supported by the crank housing, particularly with a form-closed connection, only on one axial side of the first transmission output. Said only one axial side may be referred to herein as a first axial side or first axial end. The crank housing hence supports torque from secondary axle at only one axial side of the secondary axle. The secondary axle may hence be non-rotatably coupled to the housing. Such single-sided torque-support of the secondary axle can facilitate removal of the second transmission from the crank housing at an opposite axial side, opposite said only one axial side.

Another particular aspect provides a secondary axle support, fixed to the crank housing, and arranged for torque-supporting the secondary axle at a first axial side of the first transmission output; wherein the second transmission input is releasably couplable to the first transmission output, and wherein the crank housing at a second axial side of the first transmission output, opposite the first axial side, is provided with an aperture configured for enabling the second transmission to be removed from the crank housing. The aperture is hence configured to allow removal of the second transmission from the crank housing, for example to have the second transmission repaired, maintained, and/or exchanged.

Optionally, the secondary axle is not torque-supported by the crank housing at the second axial side. Hence, optionally, the secondary axle is not torque-supported by the crank housing at an opposite axial side of the first transmission output, opposite said only one axial side. The secondary axle at the second axial side may for example be coupled or couplable to the crank housing by a force-closed connection. The connection between the crank housing and the first axial side of the secondary axle may accordingly be arranged to prohibit a relative rotation of the secondary axle with respect to the crank housing. The connection at the first axial side may hence be a form-closed connection, or, equivalently, a welded or adhesive connection. The connection between the crank housing and the second axial side of the secondary axle may accordingly be arranged to allow for rotation, e.g. slip, of the secondary axle relative to the crank housing above a torque threshold, to reduce the risk of breaking the secondary axle and/or the crank housing. The connection at the second axial side may hence be a force-closed connection. The torque threshold is preferably below a break torque of the secondary axle.

Optionally, the crank transmission assembly comprises a secondary axle support, fixed to the crank housing, and arranged for supporting the secondary axle in a torque-supporting manner at the first axial side, wherein the second transmission input is releasably couplable to the first transmission output, and wherein the crank housing at the second axial side is provided with an aperture configured for enabling the second transmission to be removed from the crank housing. The first transmission output may hence be non-removably coupled to the housing. The first transmission output may for instance be rotatably coupled to the second axle support.

Optionally, the secondary axle is releasably torque-supported by the secondary axle support and arranged for being removed from the crank housing along with the second transmission.

Optionally, the first transmission output is rotatable relative to the crank housing about the secondary axis, and non-removably connected to the crank housing.

Optionally, the crank transmission assembly comprises a, e.g. first, releasable form-closed coupling interface between the secondary axle and the secondary axle support. Alternatively, or additionally, the crank transmission assembly comprises a releasable force-closed coupling interface between the secondary axle and the secondary axle support.

Optionally, the first releasable coupling interface is configured for rotationally coupling the secondary axle and the secondary axle support while allowing relative axial sliding between the secondary axle and the secondary axle support for coupling and decoupling the secondary axle from the secondary axle support in axial direction.

Optionally, the crank transmission assembly comprises a, e.g. second, releasable form-closed coupling interface between the second transmission input and the first transmission output.

Optionally, the second releasable coupling interface is configured for rotationally coupling the first transmission output and the second transmission input while allowing relative axial sliding between the first transmission output and the second transmission input for coupling and decoupling the first transmission output and the second transmission input in axial direction.

Optionally, the secondary axle is radially supported by the crank housing only at the first axial side of the first transmission output and radially unsupported by the crank housing at an opposite second axial side of the first transmission output.

Optionally, the first transmission comprises an endless transmission member, such as a chain or belt, for transferring torque from the first transmission input to the first transmission output. Alternatively, the first transmission input and the first transmission output may engage one another directly, in absence of an endless transmission member.

Optionally, a tensioning element is provided, movably arranged relative to the crank housing for adjusting a tension of the endless transmission member.

Optionally, the second transmission includes a planetary gear set having a ring gear, a planet carrier carrying one or more stepped planet gears each having at least a first planet radius and a different second planet radius, and at least a first sun gear having a first diameter meshing with the first planet radius and a second sun gear having a smaller second diameter meshing with the second planet radius.

Optionally, the first sun gear and the second sun gear are arranged relative to each other such that the first sun gear is positioned towards the first end of the secondary axle and the second sun gear is positioned towards the second end of the secondary axle.

Optionally, the first and second sun gears are respectively coupled or couplable to the secondary axle.

Optionally, the second transmission input is positioned towards the first end of the secondary axle and the second transmission output is positioned towards the second end of the secondary axle.

Optionally, the first transmission is arranged for providing a speed increasing transmission ratio between the first transmission input and the first transmission output. Alternatively, or additionally, the first transmission may be arranged for providing a speed decreasing transmission ratio between the first transmission input and the first transmission output.

Optionally, the first transmission is a single-speed transmission arranged for be operative according to a fixed single transmission ratio. Alternatively, the first transmission is a multi-speed transmission arranged for be selectively operable according to a one of a plurality of different transmission ratios.

Optionally, the crank housing defines a sealed crank cavity in which the first transmission is accommodated, and wherein the secondary axle and the second transmission are held external to the sealed cavity.

Optionally, the crank transmission assembly comprises a module housing defining a sealed module cavity in which the secondary axle and the second transmission are accommodated, wherein the sealed module housing is releasably couplable to the crank housing.

Optionally, the crank transmission assembly comprises an electric propulsion motor for propelling the bicycle, the electric propulsion motor being arranged for driving the primary axle in rotation about the primary axis. Alternatively, the electric propulsion motor may be arranged for driving the secondary axle in rotation about the secondary axis.

Optionally, the second transmission is selectively operable according to one of a plurality of different transmission ratios.

Optionally, the second transmission is arranged for being operable according to a speed increasing and/or speed decreasing transmission ratio.

Optionally, the second transmission comprises a planetary gear set.

Optionally, a rotational member of the planetary gear set, particularly a sun gear, is coupled or couplable to the secondary axle.

Optionally, the second transmission comprises a plurality of sun gears that are respectively coupled or couplable to the secondary axle.

Optionally, the crank transmission assembly comprises an electrically powered gear shift actuator configured for shifting between the plurality of different transmission ratios.

Optionally, the electrically powered gear shift actuator is accommodated in the secondary axle.

Optionally, the hub transmission assembly comprises a third transmission operative between a third transmission input rotatable about the secondary axis and a third transmission output rotatable about the primary axis.

Optionally, the third transmission is arranged for providing a speed increasing transmission ratio and/or a speed decreasing transmission ratio between the third transmission input and the third transmission output.

Optionally, the third transmission is a single-speed transmission arranged for be operative according to a fixed single transmission ratio. Alternatively, the third transmission is a multi-speed transmission arranged for be selectively operable according to a one of a plurality of different transmission ratios.

Optionally, the third transmission comprises an endless transmission member, such as a chain or belt, for transferring torque from the third transmission input to the third transmission output. Alternatively, the third transmission input and the third transmission output may engage one another directly, in absence of an endless transmission member.

Another aspect provides a system comprising a crank transmission assembly, such as described herein, and an exchangeable sub-assembly. The crank transmission assembly comprises a crank housing; a primary axle associated with a primary axis; a first transmission operative between a first transmission input rotatable about the primary axis and a first transmission output rotatable about a secondary axis offset from the primary axis; and a secondary axle support fixed to the crank housing and configured for torque-supporting a secondary axle. The exchangeable sub- assembly comprises the secondary axle for being associated with the second axis; and a second transmission operative between a second transmission input rotatable about the secondary axle and a second transmission output rotatable about the secondary axle. The exchangeable sub-assembly is configured for being exchangeably couplable to the crank transmission assembly such that, in a coupled state, the secondary axle is torque- supported by the secondary axle support and the first transmission output is rotationally connected to the second transmission input.

An aspect provides a bicycle, comprising a crank transmission assembly as described herein. The crank housing of the crank transmission assembly may be mounted to a frame of the bicycle. The bicycle may include a crank for being rotatingly driven by a user. The crank may be connected to the primary axle. The primary axle may hence be an input of the crank transmission assembly. The secondary axle may be mounted to a chain wheel or belt wheel for cooperating with a chain or belt, and may hence be an output of the crank transmission assembly. The chain or belt wheel may transfer torque via the chain or belt to a driven wheel of the bicycle.

It will be appreciated that any of the aspects, features and options described herein can be combined.

### BRIEF DESCRIPTION OF THE DRAWINGS

Embodiments of the present invention will now be described in detail with reference to the accompanying drawings in which:

FIG. 1 shows an example of a crank transmission assembly;

FIGS. 2A and 2B show another example of a crank transmission assembly;

FIGS. 3A and 3B show another example of a crank transmission assembly;

FIGS. 4A and 4B show another example of a crank transmission assembly;

FIGS. 5A and 5B show another example of a crank transmission assembly;

FIG. 6 shows a bicycle, comprising crank transmission assembly.

### DETAILED DESCRIPTION

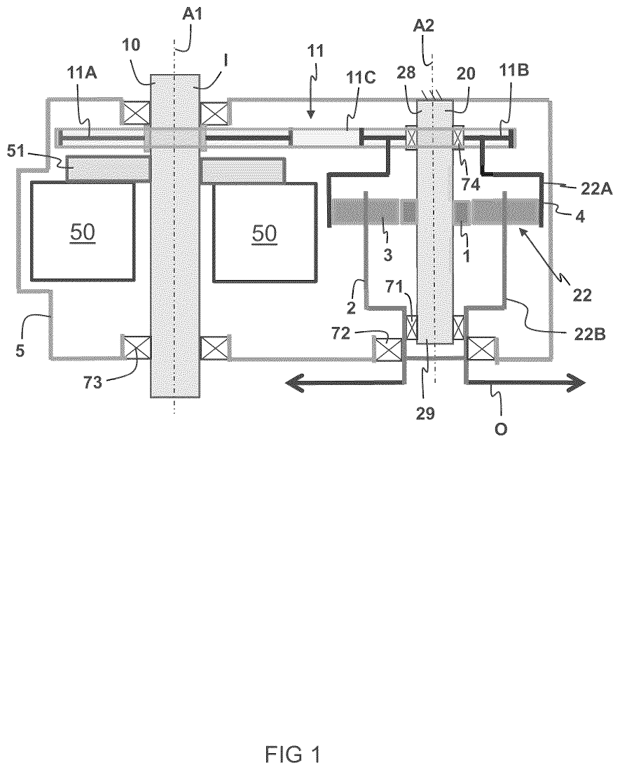

FIGS. 1, 2A and 2B, and 3A and 3B, 4A and 4B, show respective examples of a crank transmission assembly 100 for bicycle. The crank transmission assembly 100 comprises a crank housing 5. The crank housing 5 houses a primary axle 10 of the crank transmission assembly 100. The primary axle 10 is in this example an input I of the crank transmission assembly 100, and is associated with a primary axis A1. Here, the primary axle 10 extends with opposing axial ends through the crank housing 5, wherein the opposing axial ends of the primary axle 100 can be coupled to respectively a left and right crank of the bicycle. This allows a user to drive the primary axle 10 in rotation about the primary axis A1. Here, the primary axle 10 is bearing mounted to the crank housing 5 at opposing axial ends, here by bearings 73. The primary axle 10 is accordingly radially and axially supported by the crank housing 5.

The crank transmission assembly 100 also comprises a secondary axle 20. The secondary axle 20 is associated with a secondary axis A2, which is offset from the primary axis A1. The primary axle 10 and the secondary axle 20 are accordingly spaced apart from each other. The primary axle 10 and the secondary axle 20 extend particularly parallel to each other. The secondary axle 20 is in this example associated with an output of the crank transmission assembly 100. The crank transmission assembly 100 in these example is accordingly an offset crank transmission assembly 100, where the input I and output O are offset from each other, and not coaxial. The output O can be connected to a chain ring of the bicycle, which, via chain or belt, transmits rotational power to a driven wheel of the bicycle. In use, the secondary axle 20 is in this example held stationary with respect to the crank housing 5. Hereto, the secondary axle 20 is non-rotatably coupled or couplable to the crank housing 5. The secondary axle 20 is particularly torque-supportingly coupled or couplable to the crank housing 5, to allow torque forces to be transferred via the secondary axle 20 to the crank housing 5.

A first transmission 11 is operatively arranged between the first axle 10 and the second axle 20. In particular, the first transmission 11 has a first transmission input 11A which is rotatable about the primary axis A1, and a first transmission output 11B which is rotatable about the secondary axis A2. Here, the first transmission input 11A is rotationally fixed to the primary axle 10, such that the first transmission input 11A corotates with the primary axle 10 about the primary axis A1. Here, the first transmission output 11B is rotatable about the secondary axis A2 relative to the, here stationary, secondary axle 20. In these examples, the first transmission output 11B is bearing supported by the secondary axle 20, optionally via secondary axle support 6, by bearing 74. The first transmission 11 in this example comprises an endless transmission member 11C, such as a chain or belt, engaging the first transmission input 11A and the first transmission output 11B. Hence, the first transmission input 11A and the first transmission output 11B rotate in the same rotation direction about their respective rotation axis A1, A2.

A second transmission 22 is operatively arranged between a second transmission input 22A and a second transmission output 22B. The second transmission input 22A and the second transmission output 22B are rotatable about the secondary axis A2. As the secondary axle 20 is stationary in this example, the second transmission input 22A and the second transmission output 22B are rotatable about the secondary axle 20. Here, the second transmission 22 in these examples includes a planetary gear set, wherein one of the rotatable members of the planetary gear set is non-rotatably coupled or couplable to the secondary axle 20.

In the examples of FIG. 1, 2A and 2B, the second transmission 22 is operable according to a single, fixed, transmission ratio. The second transmission 22 includes a sun gear 1 that is non-ratably coupled to the secondary axle 20. The secondary transmission input 22A is formed by a ring gear 4 of the planetary gear set, and the secondary output 22B is formed by a planet carrier 2 of the planetary gear set carrying one or more planet gears 3 meshingly engaged between the sun gear 1 and the ring gear 4. It will be appreciated that such second transmission 22 is merely given by way of example, and that other arrangements are also envisioned.

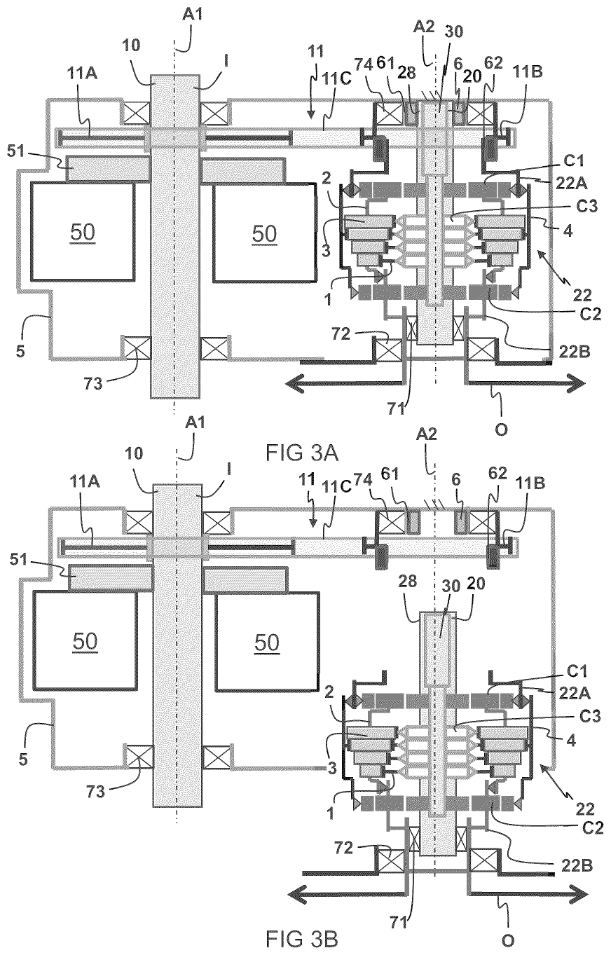

Another specific example of the second transmission 22 is for example shown in FIGS. 3A and 3B. The second transmission 22 is in this example selectively operable according to a plurality of different transmission ratios. Here, the second transmission 22 comprises four sun gears 1 meshingly engaging four respective radii of one or more stepped planet gears 3. A ring gear 4 meshingly engages with the one or more stepped planet gears 3. The second transmission input 22A is in this example selectively couplable to one of the ring gear 4 or the planet carrier 2 using an actuatable first coupling mechanism C1. The second transmission output 22B can also be selectively couplable to one of the ring gear 4 or the planet carrier 2 using an actuatable second coupling mechanism C2. Furthermore, the sun gears 1 are selectively couplable to the secondary axle 20 using a third coupling mechanism C3. Hence, any of the sun gears 1 can be braked, by coupling to the, here, stationary secondary axle 20. An electric actuator 30 is provided for actuating the third coupling mechanism C3. Here, the electric actuator 30 also actuates the first coupling mechanism C1 and the second coupling mechanism 20. Hence, by means of the electric actuator 30, a user can operate the second transmission 22, to change a transmission ratio of the second transmission 22, and thereby of a transmission ratio between the input and output of the crank transmission assembly 100.

In the examples of FIGS. 1, 2A-2B and 3A-3B, the crank transmission assembly 100 comprises an optional electric propulsion motor 50. The electric propulsion motor 50 is here arranged for driving the primary axle 10 in rotation about the primary axis A1, in this example via a reduction gearing 51. Here, the electric propulsion motor 50 is concentric with the primary axle 10, but the electric propulsion motor 50 may alternatively be offset from the primary axle 10.

In these examples, the secondary axle 20 extends between a first axial end 28 and a second axial end 29. Between the first axial end 28 and the second axial end 29, the first transmission output 11B is arranged. Also, the second transmission 22 is arranged between the first axial end 28 and the second axial end 29. Here, the secondary axle 20 is coupled to the crank housing 5 at its first axial end 28. The secondary axle 20 is particularly coupled to the crank housing 5 at its first axial end 28 in a torque supporting manner. Reaction forces on the secondary axle 20, such as resultant from the second transmission 22, can accordingly be supported via the secondary axle 20 by the crank housing 5. The secondary axle 20 is particularly coupled or couplable at its first axial end 28 to the crank housing 5 in a form-closed manner, or, equivalently, welded or glued.

At its first axial end 28, the secondary axle 20 is also axially and radially supported by the crank housing 5. At its second axial end 29, the secondary axle 20 is not torque-supported by the crank housing 5. The secondary axle 20 at its second axial end 29 may for example be force-closed coupled or couplable to the crank housing 5. A force-closed coupling may allow for a small relative rotation of the second axial end 29 of the secondary axle 20 relative to the crank housing 5, for torques above a threshold torque. The torque supporting capacity of the connection to the crank housing 5 at the second axial end 29 may hence be less than at the first axial end 28. In this example, the secondary axle 20 at its second axial end 29 is only radially supported by the crank housing 5. The second transmission 20 is arranged axially between the first transmission output 11B and the second axial end 29. The second transmission output 22B protrudes out from the crank housing 5, beyond the secondary axle 20. The second transmission output 22B is bearing supported by the secondary axle 2 and also bearing supported by the crank housing 5. The second transmission output 22B hence extends between two bearings, e.g. a between radial inner bearing 71 and a radial outer bearing 71, wherein the radial inner bearing 71 is arranged radially between the second transmission output 22B and the secondary axle 20, and the radial outer bearing 72 is arranged radially between the second transmission output 22B and the crank housing 5. The second transmission input 22A is in this example bearing mounted to the secondary axle 20 by bearing 75.

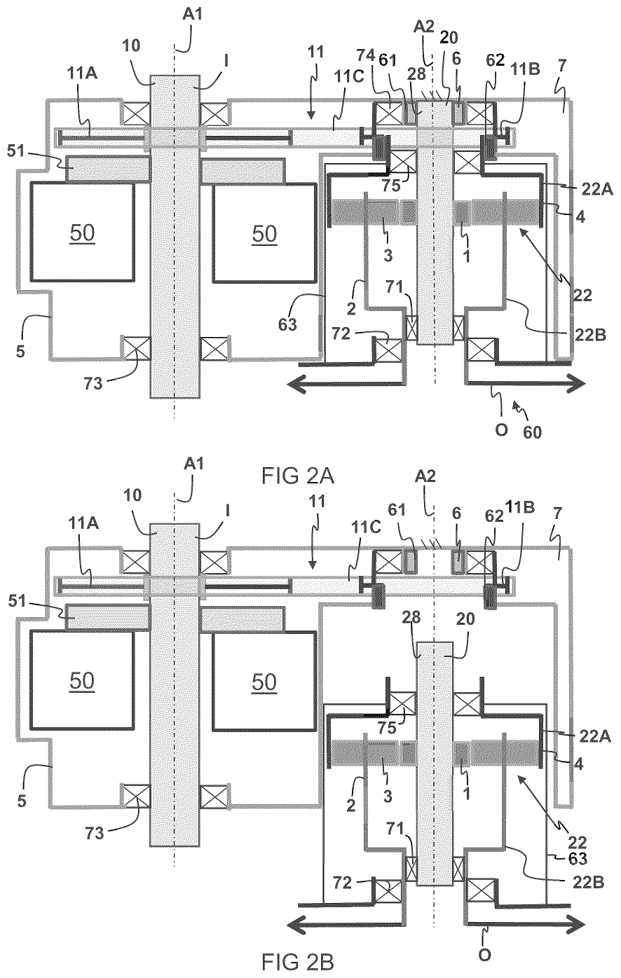

In the example of FIG. 1, the second transmission 22 is non-removably housed by the crank housing 5. In the examples of FIGS. 2A-2B, 3A-3B, the second transmission 22 is removably housed by the crank housing 5. In these examples, the second transmission 22 can accordingly be removed from the crank housing 5, for example for being serviced or exchanged, separate from the other components of the crank transmission assembly 100. Hereto, the second transmission input 11B is releasably couplable to the first transmission input 22A, for allowing coupling and decoupling of the first transmission 11 to the second transmission 22. It will be appreciated that a releasable coupling as described herein is a coupling that is intended to be released, particularly multiple times, without compromising the assembly's integrity and causing damage to the construction.

In the examples of FIGS. 2A-2B, 3A-3B, the secondary axle 20 is removable from the crank housing 5 along with the second transmission 22. The secondary axle 20 and the second transmission 22 may hence form an exchangeable sub assembly 60 of the crank transmission assembly 100.

To facilitate coupling and decoupling of this sub-assembly 60, the crank transmission assembly 100 includes a first coupling interface 61 between the secondary axle 20 and a secondary axle support 6. The secondary axle support 6 is coupled to the crank housing 5 and configured for releasably supporting the secondary axle 20 in a torque supporting manner. The first coupling interface 61 may include axial splines. The secondary axle support 6 may for example includes axial splines for cooperating with complementary axial splines provided at the first axial end 28 of the secondary axle 20. The secondary axle 20 may for example be axially slidingly received into the secondary axle support 6 for establishing a torque-supporting coupling. The crank transmission assembly 100 also includes a second coupling interface 62 between the first transmission output 11B and the second transmission input 22A. The second coupling interface 62 may also include axial splines; e.g. the first transmission output 11B and the second transmission input 22A may be provide with complementary axial splines that provide a rotational coupling about the secondary axis, and also allow for relative axial movement to enable coupling and decoupling in axial direction. The first transmission output 11B accordingly remains coupled to the crank housing 5, while the second transmission 22 is removed. The second transmission 22A is, here, bearing mounted to the secondary axle 20.

In the example of FIGS. 2A and 2B, the sub assembly 60 is housed by a sub-assembly housing 63. The crank housing 5 seals a crank cavity 7, in which the the first transmission 11 as well as the optional electric propulsion motor 50 are accommodated. Here, only the first and second coupling interfaces 61, 62 are exposed for allowing torque-supportingly coupling the secondary axle 20 to the crank housing 5, and operationally connecting the second transmission 22 to the first transmission 11. The secondary axle 20 may be axially locked to the crank housing 5, for example by a screw mount at the first axial end 28 of the secondary axle 20. Additionally or alternatively, the secondary axle 20 may be axially locked to the crank housing 5 by mounting the sub-assembly housing 7, e.g. at the second axial end 29 of the secondary axle 20, to the crank housing 5. It will be appreciated that the exemplary crank transmission assembly 100 of FIGS. 3A and 3B may similarly housed as the example of FIGS. 2A and 2B.

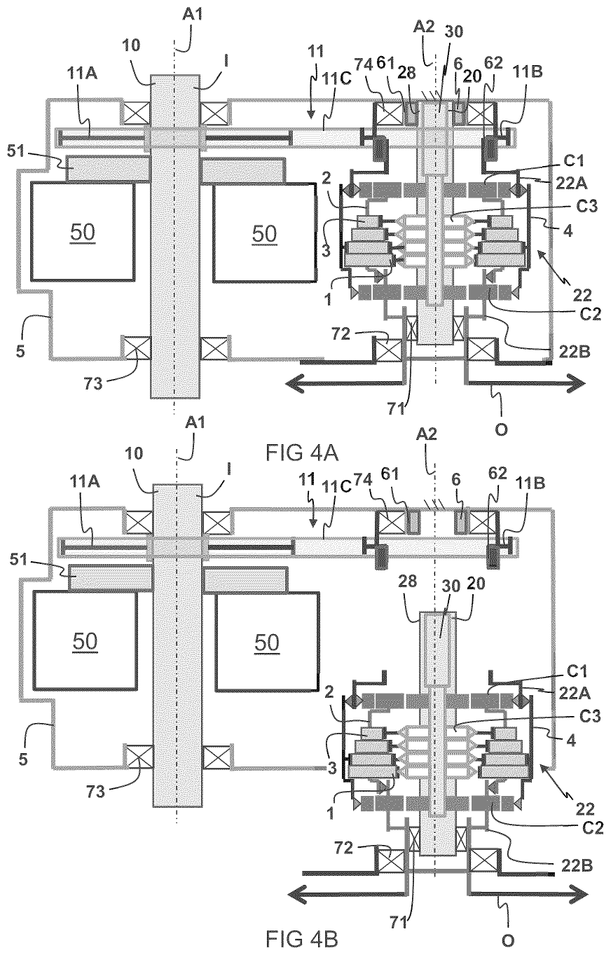

FIGS. 4A and 4B show an example of a crank transmission assembly 100 similar to the example of FIGS. 3A and 3B. The crank transmission assembly 100 shown in FIGS. 4A and 4B differ from the crank transmission assembly shown in FIGS. 3A and 3B in that the sun gears of the second transmission are arranged relative to each other with the largest sun gear being positioned towards the first axial end 28 of the secondary axle 20. The smallest sun gear of the second transmission is positioned towards the second axial end 29 of the secondary axle 20. In this arrangement, a relatively large torque is transmitted to the secondary axle 20 through the largest sun gear, which is closest to the first axial end 28 where the secondary axle is torque supported by the crank housing 5. A relatively low torque is transmitted to the secondary axle 20 through a smallest sun gear, which is further away from the first axial end 28 than the largest sun gear.

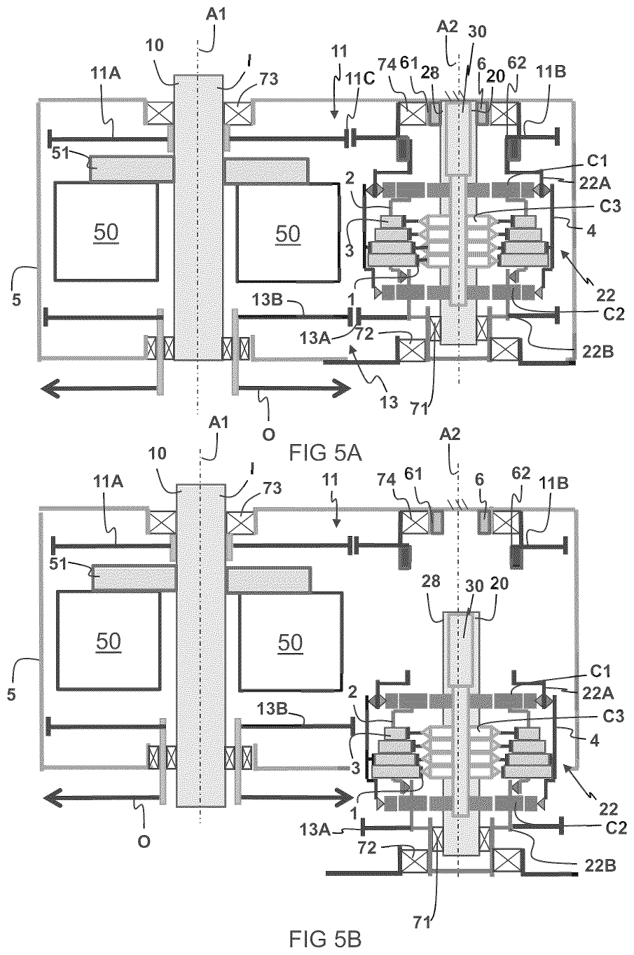

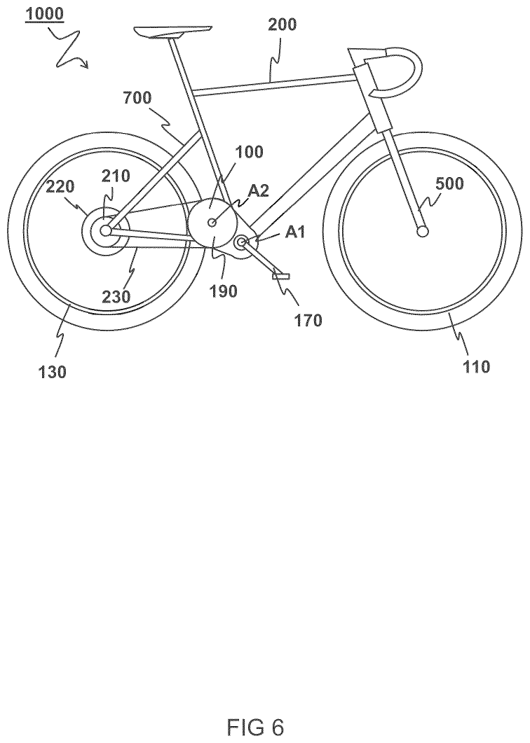

FIGS. 5A and 5B show an example of a crank transmission assembly 100 similar to the example of FIGS. 4A and 4B. The crank transmission assembly 100 shown in FIGS. 5A and 5B differ from the crank transmission assembly shown in FIGS. 4A and 4B in that the crank transmission assembly includes a third transmission 13 that is operatively arranged between the secondary axle 20 and the primary axle 10. The second transmission 12 is accordingly arranged between the first transmission 11 and the second transmission 13. The third transmission 13 has a third transmission input 13A which is rotatable about the secondary axis A2, and a third transmission output 13B which is rotatable about the primary axis A1. Hence, the input I and the output O are in this example concentric with respect to each other, as opposed to offset in examples of FIGS. 1, 2A-2B, 3A-3B, 4A-4B. In this example, the first transmission 11 and the third transmission 13 are single-speed transmissions, each operable according to a single fixed transmission ratio. It will be appreciated that the first transmission 11 and/or the second transmission 13 may alternatively be multi-speed transmissions. Also in this example, the first transmission input 11A and the first transmission output 11B are directly engaging each other, in absence of an endless transmission member. Similarly, the third transmission input 13A and the third transmission output 13B are directly engaging each other, in absence of an endless transmission member. It will be appreciated that such directly engaging transmission members may also be applied to any of the other examples. FIG. 6 shows a bicycle 1000. The bicycle 1000 comprises a frame 200 with a front fork 500 and a rear fork 700, as well as a front wheel 110 and a driven rear wheel 130 located in the front and rear fork respectively. The bicycle 1000 further comprises a crank 170, and a front chain wheel 190. In this example, a bicycle transmission assembly 100 as described herein is interconnected between the crank 170 and front chain wheel 190. The front chain wheel 190 is hence coupled to the output O of the crank transmission assembly 100 an the crank 170 is connected to the input I of the crank transmission assembly 100. The bicycle 1000 also comprises a rear sprocket 210 connected to a rear wheel hub 220 of the rear wheel 130, wherein a chain 230 threads over the front chain wheel 190 and the rear sprocket 210.

Herein, the invention is described with reference to specific examples of embodiments of the invention. It will, however, be evident that various modifications and changes may be made therein, without departing from the essence of the invention. For the purpose of clarity and a concise description features are described herein as part of the same or separate embodiments, however, alternative embodiments having combinations of all or some of the features described in these separate embodiments are also envisaged.

However, other modifications, variations, and alternatives are also possible. The specifications, drawings and examples are, accordingly, to be regarded in an illustrative sense rather than in a restrictive sense.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually 10 different claims does not indicate that a combination of these measures cannot be used to an advantage.

1. A crank transmission assembly for a bicycle, comprising a crank housing;
a primary axle associated with a primary axis;
a secondary axle offset from the primary axle and associated with a secondary axis, the secondary axle having a first end and an axially opposite second end;
a first transmission operative between a first transmission input rotatable about the primary axis and a first transmission output rotatable about the secondary axis;
a second transmission operative between a second transmission input rotatable about the secondary axis and a second transmission output rotatable about the secondary axis;
wherein the secondary axle is torque-supported by the crank housing with a form-closed connection on only the first end;
wherein the second transmission includes a planetary gear set having a ring gear, a planet carrier carrying one or more stepped planet gears each having at least a first planet radius and a different second planet radius, and at least a first sun gear having a first diameter meshing with the first planet radius and a second sun gear having a smaller second diameter meshing with the second planet radius.

2. The crank transmission assembly of claim 1, wherein the secondary axle is not torque-supported by the crank housing at the second end.

3. The crank transmission assembly of claim 2, comprising a secondary axle support, fixed to the crank housing, and arranged for supporting the secondary axle in a torque-supporting manner at only one axial side, wherein the second transmission input is releasably couplable to the first transmission output, and wherein the crank housing at said opposite axial side is provided with an aperture configured for enabling the second transmission to be removed from the crank housing.

4. A crank transmission assembly for a bicycle, comprising a crank housing;
a primary axle associated with a primary axis;
a secondary axle offset from the primary axle and associated with a secondary axis;
a first transmission operative between a first transmission input rotatable about the primary axis and a first transmission output rotatable about the secondary axis;
a second transmission operative between a second transmission input rotatable about the secondary axis and a second transmission output rotatable about the secondary axis;
a secondary axle support, fixed to the crank housing, and arranged for torque-supporting the secondary axle at a first axial side of the first transmission output;
wherein the second transmission input is releasably couplable to the first transmission output, and wherein the crank housing at a second axial side of the first transmission output, opposite the first axial side, is provided with an aperture configured for enabling the second transmission to be removed from the crank housing.

5. The crank transmission assembly according to claim 4, wherein the second transmission includes a planetary gear set having a ring gear, a planet carrier carrying one or more stepped planet gears each having at least a first planet radius and a different second planet radius, and at least a first sun gear having a first diameter meshing with the first planet radius and a second sun gear having a smaller second diameter meshing with the second planet radius.

6. The crank transmission assembly according to claim 5, wherein the first sun gear and the second sun gear are arranged relative to each other such that the first sun gear is positioned towards a first end of the secondary axle and the second sun gear is positioned towards a second end of the secondary axle.

7. The crank transmission assembly of claim 5, wherein the first and second sun gears are respectively coupled or couplable to the secondary axle.

8. The crank transmission assembly of claim 4, wherein the secondary axle is releasably torque-supported by the secondary axle support and arranged for being removed from the crank housing along with the second transmission.

9. The crank transmission assembly of claim 1, wherein the second transmission input is positioned towards the first end of the secondary axle and the second transmission output is positioned towards the second end of the secondary axle.

10. The crank transmission assembly of claim 1, wherein the first transmission is arranged for providing a speed increasing transmission ratio between the first transmission input and the first transmission output, and/or wherein the first transmission is a single-speed transmission arranged for be operative according to a fixed single transmission ratio.

11. The crank transmission assembly according to claim 1, wherein the second transmission is arranged for being operable according to a speed increasing and/or speed decreasing transmission ratio.

12. The crank transmission assembly according to claim 1, comprising a third transmission operative between a third transmission input rotatable about the secondary axis and a third transmission output rotatable about the primary axis.

13. The crank transmission assembly of claim 1, wherein the first transmission output is rotatable relative to the crank housing about the secondary axis, and non-removably connected to the crank housing.

14. The crank transmission assembly of claim 1, comprising a releasable form-closed coupling interface between the second transmission input and the first transmission output.

15. The crank transmission assembly of claim 4, comprising a releasable form-closed coupling interface between the secondary axle and the secondary axle support.

16. The crank transmission assembly of claim 4, wherein the secondary axle is radially supported by the crank housing only at the first axial side of the first transmission output and radially unsupported by the crank housing at an opposite second axial side of the first transmission output.

17. The crank transmission assembly of claim 1, wherein the first transmission comprises an endless transmission member for transferring torque from the first transmission input to the first transmission output.

18. The crank transmission assembly of claim 1, wherein the crank housing defines a sealed crank cavity in which the first transmission is accommodated, and wherein the secondary axle and the second transmission are held external to the sealed cranked cavity.

19. The crank transmission assembly of claim 1, comprising a module housing defining a sealed module cavity in which the secondary axle and the second transmission are accommodated, wherein the sealed module housing is releasably couplable to the crank housing.

20. The crank transmission assembly of claim 1, comprising an electric propulsion motor for propelling the bicycle, the electric propulsion motor being arranged for driving the primary axle in rotation about the primary axis.

21. The crank transmission assembly of claim 1, wherein the second transmission is selectively operable according to one of a plurality of different transmission ratios.

22. The crank transmission assembly of claim 21, comprising an electrically powered gear shift actuator configured for shifting between the plurality of different transmission ratios.

23. The crank transmission assembly of claim 22, wherein the electrically powered gear shift actuator is accommodated in the secondary axle.

24. A system comprising
a crank transmission assembly including:
a crank housing;
a primary axle associated with an primary axis;
a first transmission operative between a first transmission input rotatable about the primary axis and a first transmission output rotatable about a secondary axis offset from the primary axis; and
a secondary axle support fixed to the crank housing and configured for torque-supporting a secondary axle; and
an exchangeable sub-assembly including
the secondary axle for being associated with the second axis; and
a second transmission operative between a second transmission input rotatable about the secondary axle and a second transmission output rotatable about the secondary axle;
wherein the exchangeable sub-assembly is configured for being exchangeably couplable to the crank transmission assembly such that, in a coupled state, the secondary axle is torque-supported by the secondary axle support and the first transmission output is rotationally connected to the second transmission input.
